(19) United States
(12) Patent Application Publication
(10) Pub. No.: US 2015/0065179 A1
(43) Pub. Date: Mar. 5, 2015

(54) PRE-PAGING INDICATION IN ATI AND PSI

(71) Applicant: Jozsef Molnar, Budapest (HU)

(72) Inventor: Jozsef Molnar, Budapest (HU)

(73) Assignee: NOKIA SOLUTIONS AND NETWORKS OY, Espoo (FI)

(21) Appl. No.: 14/395,122

(22) PCT Filed: Apr. 17, 2012
(86) PCT No.: PCT/EP2012/056991

§ 371 Date: Oct. 17, 2014

(51) Int. Cl. H04W 68/02

(52) U.S. Cl. CPC H04W 68/02
USPC 455/458

(57) ABSTRACT

It is provided an apparatus, comprising checking means adapted to check, upon receipt of a detection point of a service for a subscriber, if a pre-paging support is related to the service; interrogating means adapted to interrogate a location of the subscriber, wherein the interrogation comprises an indication of the pre-paging support if the result of the checking by the checking means is affirmative.

### FIELD OF THE INVENTION

The present invention relates to an apparatus, a method, a system, and a computer program product related to improving the setup of a call. More particularly, the present invention relates to an apparatus, a method, a system, and a computer program product for improved setup of a terminating service in case of a terminating calls.

### BACKGROUND OF THE INVENTION

### Abbreviations

3GPP 3^{rd} generation partnership project

ATI AnyTimeInterrogation

CSI Camel Subscription Information

DP Detection Point

GMSS Gateway Mobile Switching Center Server

GPRS Global Packet Radio Service

GSM Global System for Mobile Communication

HLR Home Location Register

LTE Long Term Evolution

MAP Mobile Application Part

MSS Mobile Switching Center Server

PRN ProvideRoamingNumber

PSI ProvideSubscriberInfo

SCP Service Control Point

SRI SendRoutingInformation

T-CSI Temporary CSI

TS Technical Specification

VLR Visiting Location Register

VT-MSS Visiting Terminating MSS

A typical mobile terminated call involves a gateway MSS (GMSS), an HLR, a VLR and a visiting terminating MSS (VT-MSS). The VLR and the VT-MSS may be physically the same network element. GMSS receives the incoming call from another mobile or fixed switching exchange. GMSS interrogates HLR by a MAP-SendRoutingInformation (SRI) message for a roaming number and terminating services of the subscriber. HLR further sends a MAP-ProvideRoamingNumber (PRN) to the VLR where the subscriber is actually registered. Then the VLR reserves a roaming number (MSRN), which is transferred back to the GMSS, which then can route the call to the VT-MSS. Normally, the paging of the subscriber over the radio network happens in this phase by the VT-MSS (referred as “normal paging”).

However, if GMSS and HLR both support the pre-paging functionality then they indicate this in the SRI and PRN operations to the VLR and then VLR initiates the pre-paging (referred as “PRN pre-paging”) of the subscriber before the roaming number reservation. In this case the radio resources are kept reserved until the call is routed to the VT-MSS. This is standardized functionality according to 3GPP TS 23.018 and 29.002.

If the subscriber has terminating intelligent network (IN) services indicated in HLR then HLR may first return these services to the GMSS without sending PRN to the VLR. The GMSS triggers the service towards an SCP, which can initiate a query for the subscriber's current location. The query is a MAP-AnyTimeInterrogation (ATI) message to the HLR, which then sends a MAP-ProvideSubscriberInfo (PSI) to the VLR. The VLR in this case initiates a paging (referred as “PSI paging”) for the subscriber, because the exact location of the user can be detected during an established radio contact. After the subscriber responded the paging request, the radio resources are released immediately and VLR responds with the location information to HLR, which then responds to SCP, which then responds to the GMSS. Then GMSS initiates another SRI operation for the roaming number and the message flow goes as described above. This is also standardized functionality according to 3GPP TS 23.078 and 29.002.

As it can be seen in the above situation (the subscriber has terminating services, which require the current location of the user), the subscriber is paged twice in the same terminating call, which wastes radio resources. For this reason, according to a not-standardized implementation, the pre-paging type of functionality in the VLR is implemented also at PSI operation (referred as “PSI pre-paging”). In this case the VLR and VT-MSS do not release the radio resources after the subscriber's current location is determined, but keep the connection alive until the call is finally routed to the VT-MSS (just like in PRN related pre-paging). A relevant difference between PRN and PSI related pre-paging is that PSI does not include any indication about the pre-paging support, but it is triggered by the VLR based on an internal configuration parameter.

### SUMMARY OF THE INVENTION

It is an object of the present invention to improve the prior art.

According to a first aspect of the invention, there is provided an apparatus, comprising checking means adapted to check, upon receipt of a detection point of a service for a subscriber, if a pre-paging support is related to the service; interrogating means adapted to interrogate a location of the subscriber, wherein the interrogation comprises an indication of the pre-paging support if the result of the checking by the checking means is affirmative.

In the apparatus, the interrogation may not comprise the indication of the pre-paging support if the result of the checking by the checking means is not affirmative.

According to a second aspect of the invention, there is provided an apparatus, comprising checking processor adapted to check, upon receipt of a detection point of a service for a subscriber, if a pre-paging support is related to the service; interrogating processor adapted to interrogate a location of the subscriber, wherein the interrogation comprises an indication of the pre-paging support if the result of the checking by the checking processor is affirmative.

In the apparatus, the interrogation may not comprise the indication of the pre-paging support if the result of the checking by the checking processor is not affirmative.

According to a third aspect of the invention, there is provided a service control point comprising an apparatus according to any of the first and second aspects.

According to a fourth aspect of the invention, there is provided an apparatus, comprising deciding means adapted to decide if a received interrogation for a location of a subscriber comprises a pre-paging support indication; location requesting means adapted to request a location of the subscriber upon receipt of the interrogation, wherein the request for the location comprises the pre-paging support indication if the deciding by the deciding means is affirmative.

In the apparatus, the request may not comprise the pre-paging support indication if the deciding by the deciding means is not affirmative.

According to a fifth aspect of the invention, there is provided an apparatus, comprising deciding processor adapted to decide if a received interrogation for a location of a subscriber comprises a pre-paging support indication; location requesting processor adapted to request a location of the subscriber upon receipt of the interrogation, wherein the request for the location comprises the pre-paging support indication if the deciding by the deciding processor is affirmative.

In the apparatus, the request may not comprise the pre-paging support indication if the deciding by the deciding processor is not affirmative.

According to a sixth aspect of the invention, there is provided a home location register comprising an apparatus according to any of the fourth and fifth aspects.

According to a seventh aspect of the invention, there is provided an apparatus, comprising deciding means adapted to decide if a received request for information on a location of a subscriber comprises a pre-paging support indication; resource reserving means adapted to reserve a radio resource after the paging if the decision by the deciding means is affirmative, wherein the radio resource is scheduled for paging upon the request for information; and at least one of first suppressing means adapted to suppress paging upon receipt of a request for a roaming number of the subscriber if the decision by the deciding means is affirmative; and second suppressing means adapted to suppress paging upon receipt of a request to set up a call to the subscriber if the decision by the deciding means is affirmative.

The apparatus may further comprise releasing means adapted to release the radio resource after the paging upon receipt of the request for information of the subscriber if the decision by the deciding means is not affirmative.

The apparatus comprising the second suppressing means may further comprise setup means adapted to set up, upon receipt of the request to set up the call, the call to the subscriber using the reserved radio resource if the decision by the deciding means is affirmative.

According to an eighth aspect of the invention, there is provided an apparatus, comprising deciding processor adapted to decide if a received request for information on a location of a subscriber comprises a pre-paging support indication; resource reserving processor adapted to reserve a radio resource after the paging if the decision by the deciding processor is affirmative, wherein the radio resource is scheduled for paging upon the request for information; and at least one of first suppressing processor adapted to suppress paging upon receipt of a request for a roaming number of the subscriber if the decision by the deciding processor is affirmative; and second suppressing processor adapted to suppress paging upon receipt of a request to set up a call to the subscriber if the decision by the deciding processor is affirmative.

The apparatus may further comprise releasing processor adapted to release the radio resource after the paging upon receipt of the request for information of the subscriber if the decision by the deciding processor is not affirmative.

The apparatus comprising the second suppressing processor may further comprise setup processor adapted to set up, upon receipt of the request to set up the call, the call to the subscriber using the reserved radio resource if the decision by the deciding processor is affirmative.

According to a ninth aspect of the invention, there is provided a mobile switching center server comprising a visiting location register and comprising an apparatus according to any of the seventh and eighth aspects.

According to a tenth aspect of the invention, there is provided a system, comprising a control apparatus according to any of the first and second aspects; and a register apparatus according to any of the fourth and fifth aspects; wherein the interrogation of the register apparatus comprises the interrogation of the control apparatus and the pre-paging support indication of the register apparatus comprises the indication of the pre-paging support of the control apparatus.

According to an eleventh aspect of the invention, there is provided a method, comprising checking, upon receipt of a detection point of a service for a subscriber, if a pre-paging support is related to the service; interrogating a location of the subscriber, wherein the interrogation comprises an indication of the pre-paging support if the result of the checking is affirmative.

The method may be a method of pre-paging control.

In the method, the interrogation may not comprise the indication of the pre-paging support if the result of the checking is not affirmative.

According to a twelfth aspect of the invention, there is provided a method, comprising deciding if a received interrogation for a location of a subscriber comprises a pre-paging support indication; requesting a location of the subscriber upon receipt of the interrogation, wherein the request for the location comprises the pre-paging support indication if the deciding is affirmative.

The method may be a method of pre-paging control.

In the method, the request may not comprise the pre-paging support indication if the deciding is not affirmative.

According to a thirteenth aspect of the invention, there is provided a method, comprising deciding if a received request for information on a location of a subscriber comprises a pre-paging support indication; and, if the decision is affirmative: keeping a radio resource reserved after the paging, wherein the radio resource is scheduled for paging upon the request for information; and at least one of suppressing paging upon receipt of a request for a roaming number of the subscriber; and suppressing paging upon receipt of a request to set up a call to the subscriber.

The method may be a method of pre-paging control.

The method may further comprise releasing the radio resource after the paging upon receipt of the request for information of the subscriber if the decision is not affirmative.

The method comprising suppressing paging upon receipt of the request to set up the call may further comprise setting up, upon receipt of the request to set up the call, the call to the subscriber using the reserved radio resource.

According to a fourteenth aspect of the invention, there is provided a computer program product including a program comprising software code portions being arranged, when run on a processor of an apparatus, to perform the method according to any one of the eleventh to thirteenth aspects.

The computer program product may comprise a computer-readable medium on which the software code portions are stored, and/or the program may be directly loadable into a memory of the processor.

According to embodiments of the invention, at least the following advantages are achieved:

The PSI operation is optimized with respect to the pre-paging functionality by distinguishing between services requiring reservation of radio resources and services which do not require reservation. Thus, a waste of radio resources is avoided.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred embodiments of the present invention which is to be taken in conjunction with the appended drawings, wherein

FIG. 1 shows a message flow according to an embodiment of the invention;

FIG. 2 shows another message flow according to an embodiment of the invention;

FIG. 3 shows a message flow according to the prior art;

FIG. 4 shows an apparatus according to an embodiment of the invention;

FIG. 5 shows a method according to an embodiment of the invention.

FIG. 6 shows an apparatus according to an embodiment of the invention;

FIG. 7 shows a method according to an embodiment of the invention;

FIG. 8 shows an apparatus according to an embodiment of the invention; and

FIG. 9 shows a method according to an embodiment of the invention.

### DETAILED DESCRIPTION OF CERTAIN EMBODIMENTS

Herein below, certain embodiments of the present invention are described in detail with reference to the accompanying drawings, wherein the features of the embodiments can be freely combined with each other unless otherwise described. However, it is to be expressly understood that the description of certain embodiments is given for by way of example only, and that it is by no way intended to be understood as limiting the invention to the disclosed details.

Moreover, it is to be understood that the apparatus is configured to perform the corresponding method, although in some cases only the apparatus or only the method are described.

The ATI+PSI can be triggered by various services and the PSI pre-paging functionality does not necessarily fit to all services. Some services are not related to any mobile terminated calls and so the radio resources should not be kept reserved after the paging response. That is, instead of PSI pre-paging, a normal PSI paging should be performed when these services are triggered.

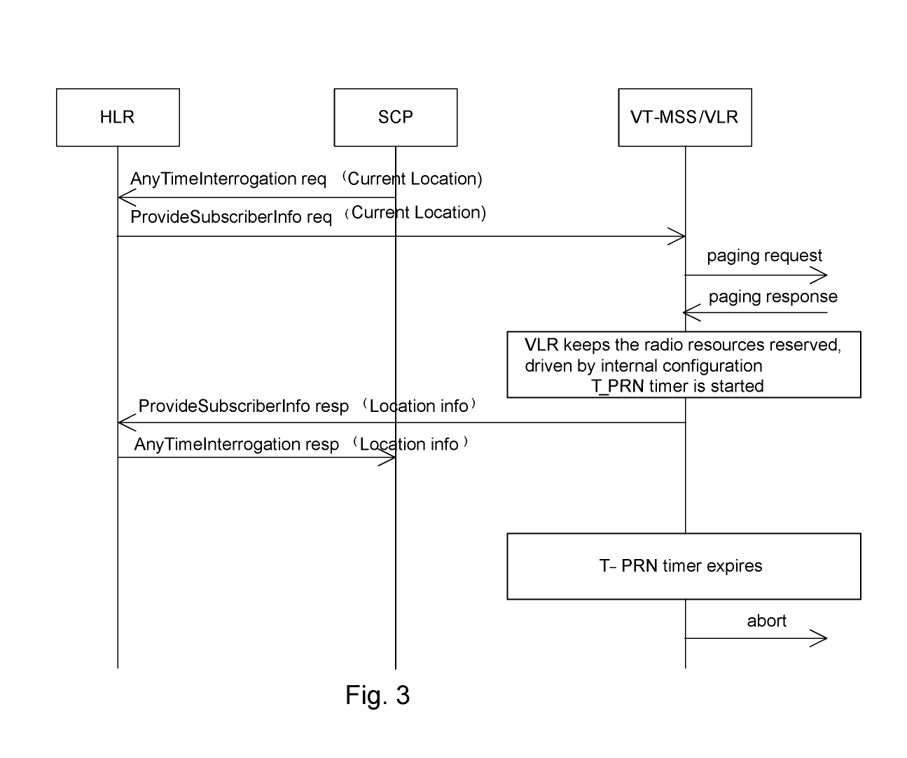

FIG. 3 shows a message flow for such a service according to the above described non-standardized solution. The result of the PSI not comprising the “pre-paging supported” indication is that VT-MSS keeps the radio resources reserved after paging. In a case, where no terminating call will be set up to the subscriber, the radio resources remain reserved until a certain guard timer (e.g. named T_PRN) expires and then aborts the procedure towards the mobile subscriber. This case is shown in FIG. 3. On the other hand, if a terminating call follows, a PRN will arrive before the guard timer expires, to use the radio resources for the terminating call (not shown in FIG. 3). While the latter case does not cause a problem, the former case causes unnecessary reservation of radio resources.

Currently the VLR has no means to differentiate PSI operations that should support pre-paging from PSI operations that should not support pre-paging.

According to embodiments of the invention, the “pre-paging supported” indication is comprised in the MAP-AnyTimeInterrogation and MAP-ProvideSubscriberInfo operations corresponding to its availability in MAP-SendRoutingInformation and MAP-ProvideRoamingNumber operations.

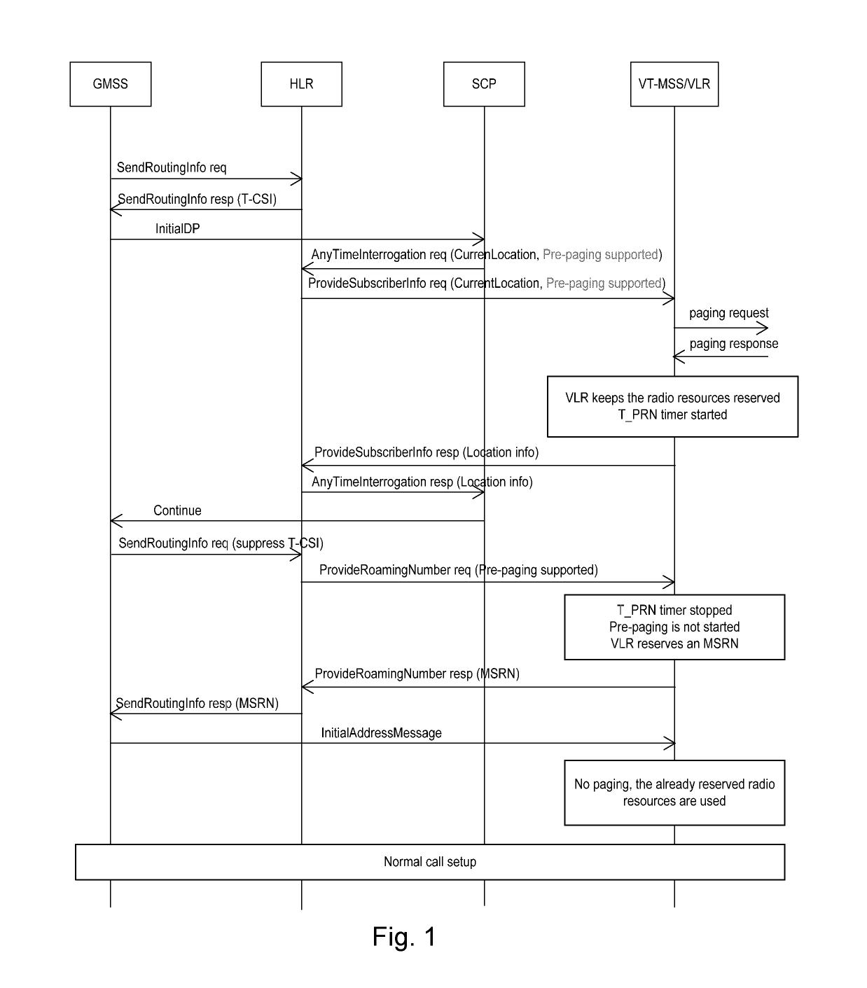

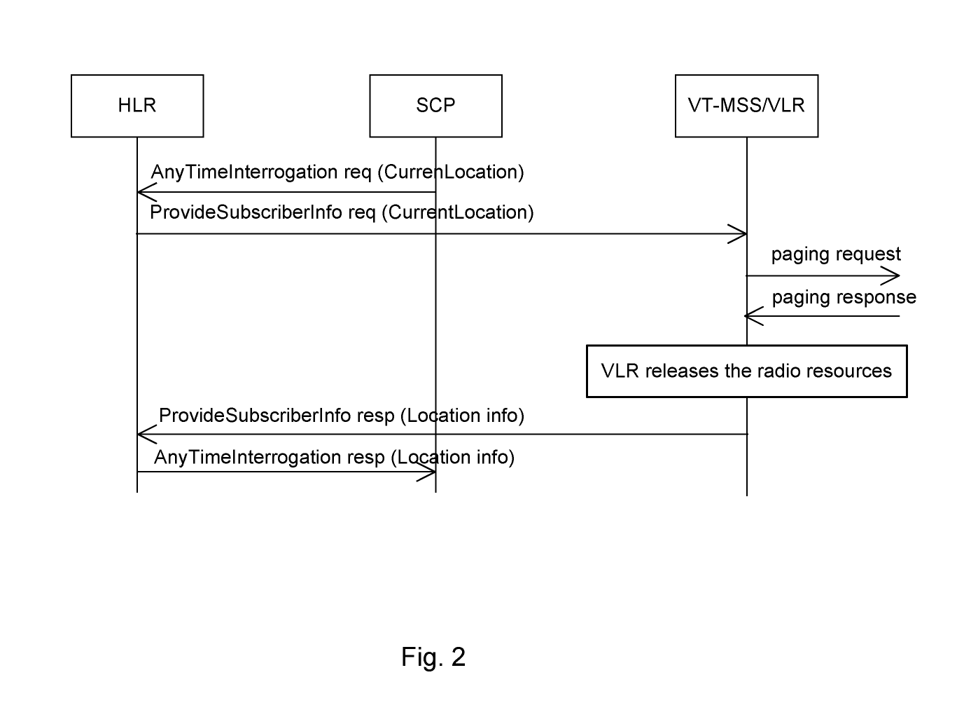

In detail, the service logic (SCP) indicates “pre-paging supported” in the MAP-AnyTimeInterrogation operation towards HLR when a mobile terminating call setup would possibly follow the interrogation. The HLR may further indicate the “pre-paging supported” indication in MAP-ProvideSubscriberInfo operation towards VLR. Preferably, VLR should initiate PSI pre-paging only if its support is indicated in the PSI request as shown in FIG. 1, otherwise VLR should do a normal PSI paging as shown in FIG. 2. This way the radio resources are kept reserved in those cases when a call will be established towards the paged subscriber. Otherwise the radio resources may be released immediately and not only after some long timer expiry.

Some message flows are shown in FIGS. 1 to 3. FIG. 1 indicates a message flow of a mobile terminated call sequence with PSI related pre-paging according to an embodiment of the invention. FIG. 2 indicates a message flow for a service that is not related to a mobile terminated call, for example, a periodic location query (e.g. some tracking service) according to an embodiment of the invention. In this case, VLR notices that “pre-paging supported” is not included in the PSI request, and so it does not keep the radio resources reserved. FIG. 3 indicates a conventional message flow for the same periodic location request service as in FIG. 2. In this conventional case, the VLR applies pre-paging for all PSI queries, and the reserved resources are only released after a timer is expired.

According to some embodiments, the SCP may store for each service a “pre-paging supported” indication. This indication may be true if the above described condition is fulfilled (i.e. an MT call setup may possibly follow the service), and false otherwise. Alternatively, the SCP may store a “pre-paging supported” indication only for those services where the above described condition is fulfilled and not for other services. According to still other embodiments, the SCP may prove whether the service logic comprises certain commands for which a later paging is required, e.g. a command to set up a MT call.

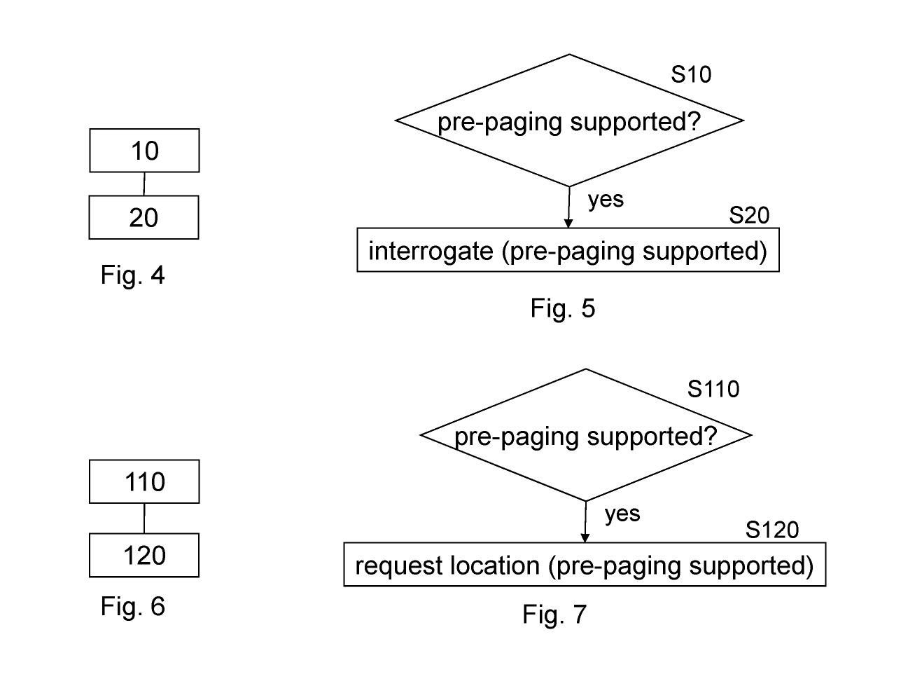

FIG. 4 shows an apparatus according to an embodiment of the invention. The apparatus may be a service control point. The apparatus according to FIG. 4 may perform the method of FIG. 5 but is not limited to this method. The method of FIG. 5 may be performed by the apparatus of FIG. 4 but is not limited to being performed by this apparatus.

The apparatus comprises checking means 10 and interrogating means 20.

Upon receipt of a detection point of a service for a subscriber (i.e. after receipt of an InitialDetectionPoint), the checking means 10 may check, if a “pre-paging supported” indication is related to the service (S10). If yes, the interrogating means 20 may interrogate a location of the subscriber, wherein the interrogation comprises the “pre-paging supported” indication (S20).

FIG. 6 shows an apparatus according to an embodiment of the invention. The apparatus may be a home location register. The apparatus according to FIG. 6 may perform the method of FIG. 7 but is not limited to this method. The method of FIG. 7 may be performed by the apparatus of FIG. 6 but is not limited to being performed by this apparatus.

The apparatus comprises deciding means 110 and requesting means 120.

If an interrogation for a location of a subscriber is received, the deciding means (110) decides if the interrogation comprises a “pre-paging supported” indication (S110). If yes, the location requesting means 120 requests a location of the subscriber, wherein the request for the location comprises the “pre-paging supported” indication (S120).

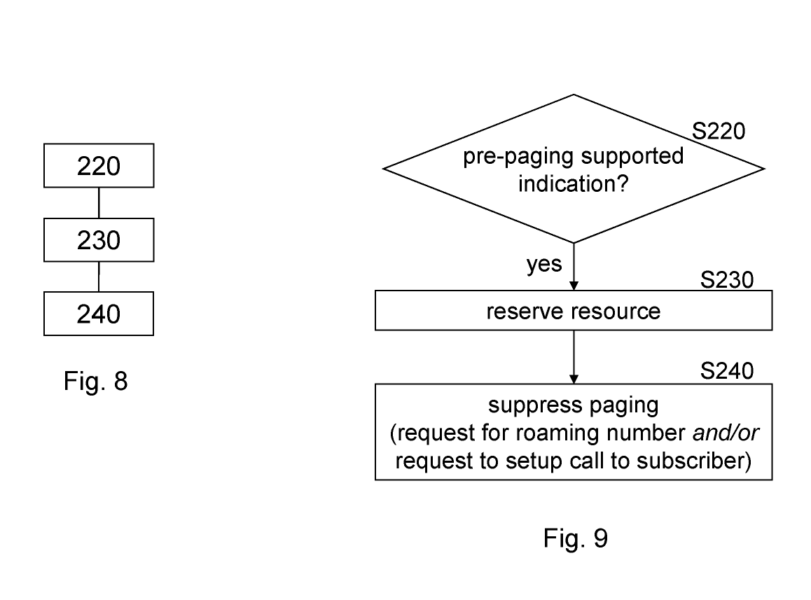

FIG. 8 shows an apparatus according to an embodiment of the invention. The apparatus may be a mobile switching service center including a visiting location register. The apparatus according to FIG. 8 may perform the method of FIG. 9 but is not limited to this method. The method of FIG. 9 may be performed by the apparatus of FIG. 8 but is not limited to being performed by this apparatus.

The apparatus comprises deciding means 220, resource reserving means 230, and suppressing means 240.

The deciding means 220 decides if a received request for information on the location of the subscriber comprises a pre-paging supported indication (S220). If the deciding means 220 decides affirmatively, i.e., the pre-paging supported is comprised in the request for information on the location, the resource reserving means 230 and the suppressing means 240 may act as follows:

The resource reserving means 230 may keep a radio resource which was scheduled for paging upon the request for information on the location reserved after paging (S230); the suppressing means 240 may suppress paging upon receipt of a request for the roaming number of the subscriber. This paging is preferably suppressed if the request for the roaming number comprises a pre-paging supported indication. In addition, or alternatively, the suppressing means 240 may suppress paging upon receipt of a request to set up a call to the subscriber (S240).

According to some embodiments, a setup means may set up, upon receipt of the request to set up the call, the call to the subscriber using the reserved radio resource.

In some embodiments, if the decision by the deciding means 220 is not affirmative, a first releasing means may release the radio resource after the paging upon receipt of the request for information.

Embodiments of the invention are described with respect to a 3GPP network. However, embodiments of the invention may be applied to GSM networks, GPRS networks, LTE networks etc., too.

If not otherwise stated or otherwise made clear from the context, the statement that two entities are different means that they are differently addressed in their respective network. It does not necessarily mean that they are based on different hardware. That is, each of the entities described in the present description may be based on a different hardware, or some or all of the entities may be based on the same hardware.

According to the above description, it should thus be apparent that exemplary embodiments of the present invention provide, for example a control apparatus such as a SCP, or a component thereof, an apparatus embodying the same, a method for controlling and/or operating the same, and computer program(s) controlling and/or operating the same as well as mediums carrying such computer program(s) and forming computer program product(s). Furthermore, it should thus be apparent that exemplary embodiments of the present invention provide, for example a register apparatus such as a HLR, or a component thereof, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques or methods include, as non limiting examples, implementations as hardware, software, firmware, special purpose circuits or logic, general purpose hardware or controller or other computing devices, or some combination thereof.

It is to be understood that what is described above is what is presently considered the preferred embodiments of the present invention. However, it should be noted that the description of the preferred embodiments is given by way of example only and that various modifications may be made without departing from the scope of the invention as defined by the appended claims.

1. An apparatus, comprising:
checking means for checking, upon receipt of a detection point of a service for a subscriber, if a pre-paging support is related to the service;
interrogating means for interrogating a location of the subscriber, wherein the interrogation comprises an indication of the pre-paging support if the result of the checking by the checking means is affirmative.

2. The apparatus according to claim 1, wherein the interrogation does not comprise the indication of the pre-paging support if the result of the checking by the checking means is not affirmative.

3. A service control point comprising an apparatus according to claim 1.

4. An apparatus, comprising:
deciding means for deciding if a received interrogation for a location of a subscriber comprises a pre-paging support indication;
location requesting means for requesting a location of the subscriber upon receipt of the interrogation, wherein the request for the location comprises the pre-paging support indication if the deciding by the deciding means is affirmative.

5. The apparatus according to claim 4, wherein the request does not comprise the pre-paging support indication if the deciding by the deciding means is not affirmative.

6. A home location register comprising an apparatus according to claim 4.

7. An apparatus, comprising:
deciding means for deciding if a received request for information on a location of a subscriber comprises a pre-paging support indication;
resource reserving means for reserving a radio resource after the paging if the decision by the deciding means is affirmative, wherein the radio resource is scheduled for paging upon the request for information; and at least one of
first suppressing means for suppressing paging upon receipt of a request for a roaming number of the subscriber if the decision by the deciding means is affirmative; and
second suppressing means adapted to suppress paging upon receipt of a request to set up a call to the subscriber if the decision by the deciding means is affirmative.

8. The apparatus according to claim 7, further comprising:
releasing means for releasing the radio resource after the paging upon receipt of the request for information of the subscriber if the decision by the deciding means is not affirmative.

9. The apparatus according to claim 7 comprising the second suppressing means and further comprising
setup means for setting up, upon receipt of the request to set up the call, the call to the subscriber using the reserved radio resource if the decision by the deciding means is affirmative.

10. A mobile switching center server comprising a visiting location register and comprising an apparatus according to claim 7.

11. A system, comprising
an apparatus according to claim 1; and
a register apparatus, comprising deciding means for deciding if a received interrogation for a location of a subscriber comprises a pre-paging support indication; location requesting means for requesting a location of the subscriber upon receipt of the interrogation, wherein the request for the location comprises the pre-paging support indication if the deciding by the deciding means is affirmative; wherein
the interrogation of the register apparatus comprises interrogation of the control apparatus and the pre-paging support indication of the register apparatus comprises the indication of the pre-paging support of the control apparatus.

12. A method, comprising:
checking, upon receipt of a detection point of a service for a subscriber, if a pre-paging support is related to the service;
interrogating a location of the subscriber, wherein the interrogation comprises an indication of the pre-paging support if the result of the checking is affirmative.

13. The method according to claim 12, wherein the interrogation does not comprise the indication of the pre-paging support if the result of the checking is not affirmative.

14. A method, comprising:
deciding if a received interrogation for a location of a subscriber comprises a pre-paging support indication;
requesting a location of the subscriber upon receipt of the interrogation, wherein the request for the location comprises the pre-paging support indication if the deciding is affirmative.

15. The method according to claim 14, wherein the request does not comprise the pre-paging support indication if the deciding is not affirmative.

16. A method, comprising:
deciding if a received request for information on a location of a subscriber comprises a pre-paging support indication; and, if the decision is affirmative:
keeping a radio resource reserved after the paging, wherein the radio resource is scheduled for paging upon the request for information; and at least one of
suppressing paging upon receipt of a request for a roaming number of the subscriber; and
suppressing paging upon receipt of a request to set up a call to the subscriber.

17. The method according to claim 16, further comprising
releasing the radio resource after the paging upon receipt of the request for information of the subscriber if the decision is not affirmative.

18. The method according to claim 16, comprising suppressing paging upon receipt of the request to set up the call, further comprising
setting up, upon receipt of the request to set up the call, the call to the subscriber using the reserved radio resource.

19. A computer program embodied on a non-transitory computer-readable medium, including a program comprising software code portions being configured, when run on a processor of an apparatus, to perform the method according to claim 12.

20. (canceled)
